(19) United States
(12) Patent Application Publication
(10) Pub. No.: US 2006/0092858 A1
(43) Pub. Date: May 4, 2006

(54) Method for transmitting data in a communication system

(76) Inventors: Rigobert Kynast, Loht am Main (DE); Ludwig Leurs, Lohr am Main (DE); Thomas Schmid, Hafenlohr (DE); Stephan Schultze, Lohr am Main (DE)

Correspondence Address: STRIKER, STRIKER & STENBY, 103 EAST NECK ROAD, HUNTINGTON, NY, 11743, US

(21) Appl. No.: 11/247,829

(22) Filed: Oct. 11, 2005

(30) Foreign Application Priority Data
Oct. 15, 2004 (DE) 10 2004 050 424.5

(51) Int. Cl. H04L 12/28

(52) U.S. Cl. 370/254

(57) ABSTRACT

Transmission of data in a communication system including a central participant and at least one further participant includes transmitting the data via telegrams from the at least one further participant to the center participant, transmitting the telegrams by the central participant to the at least one further participant before being sent out by the at least one further participant, adding by the central participant a predetermined entry in the telegram in at least one location assigned to the at least one further participant, and adding by the at least one further participant to the telegram the data to be transmitted to the central participant such that the entry added by the central participant is at least partially overwritten.

The present invention relates to a method for transmitting data in a communication system that includes a central participant and at least one further participant, at least one of the further participants transmitting data to the central participant via telegrams, the telegrams having been transmitted by the central participant to the at least one further participant before being sent out by the at least one further participant. The present invention further relates to a communication system and a corresponding automation system.

With regard for the disclosure of the present application, reference is also made to the additional German patent applications submitted by the applicant simultaneously with the present patent application, entitled “Verfahren zur Synchronisation in einem Redundanten Kommunikationssystem” (Method for Synchronization in a Communication System) and “Kommunikationssystem und Verfahren zur Synchronisation desselben” (Communication System and Method for Synchronization of the Same), the entire disclosure of which is included via this reference in the present application.

Communication systems are known from the related art. Distributed communication systems, in particular, are utilized in many technical applications. Distributed communication systems are used, e.g., in automation systems based on decentralized control and drive system engineering, in which a large number of individual systems are often controlled and driven in a temporally synchronized manner. An example of a single system of this type is a drive unit, e.g., a synchronous or asynchronous motor used to drive one of many axes that function in a manner such that they are mutually interpolating or closely interconnected. Typical fields of application of automation systems of this type based on decentralized control and drive system engineering are printing machines or machine tools, and robotic systems with a large number of conveying and operating elements harmonized with respect to time.

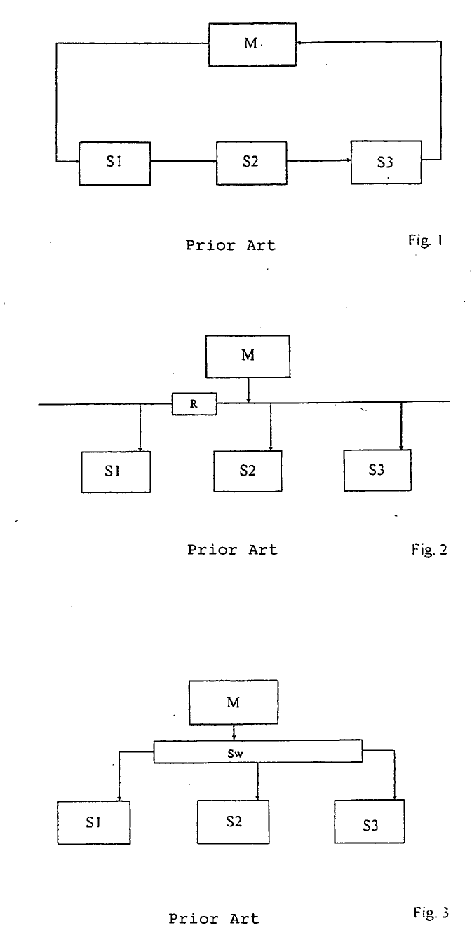

Communication systems of this type include at least two, but usually many more participants, which are preferably configured and/or arranged in a hierarchical structure, with one participant being configured as the central participant and the remaining participants being configured and/or arranged as further participants in the communication system. A hierarchical architecture of this type is known, e.g., as a master-slave structure with the central or main participant as the “master” or “master participant” (main station), and the further participants as “slaves” or “slave participants” (substations or secondary stations). The main participant is designed as the central participant that generates and sends control signals to the further participants. The further participants are in communication contact with the central participant to receive these control signals and to communicate further with the central participant, as necessary, and they are typically in communication contact with the other participants as well. The slave participants are usually process interfaces, such as sensors and actuators, i.e., input/output assemblies for analog and digital signals, and drives. Signal processing, with data preprocessing, must be decentralized among the slave participants to keep the quantity of data to be transmitted low. This requires that the master participant and the further slave participants communicate with each other. In this regard, three basic architectures (“topologies”) are known from the related art. They are illustrated in FIGS. 1 through 3. In FIG. 1, central participant M and further participants S1, S2, S3 are interconnected in a ring structure. A signal generated by central participant M travels around the ring and therefore passes each of the other participants S1, S2, and S3 in series. FIG. 2 shows a bus topology with a centralized bus line to which central participant M and further participants S1, S2 and S3 are connected. The signal and data transfer is accomplished via a data bus in a known manner. When the central bus line has long paths, it is common to interconnect a “repeater” R in the central bus line to amplify the signal. The third structure shown in FIG. 3 is a star architecture with a central switching element Sw (a “switch”) integrated in the connecting line. A signal generated by central participant M is relayed via switching element Sw to participant S1 or S2 or S3 specified as the receiver.

The three topologies shown in FIGS. 1 through 3 can also be part of a more complex system in which a plurality of basic architecture designs are realized in an interconnected manner. In this case, one of the central participants or a superordinate central participant has the task of generating a superordinate control signal.

Distributed communication systems are also known from the related art, with which the master function can be transferred among a plurality of participants or even among all participants. A requirement of “multi-master” systems of this type is that a plurality of participants has the functionality of a central participant and that they exercise this functionality when a defined condition exists. In this process, a participant that previously served as a further participant becomes the central participant, and the previous central participant becomes the further participant in the communication system. A possible condition for a transfer of this type can be, e.g., the absence of a control signal from the previous central participant.

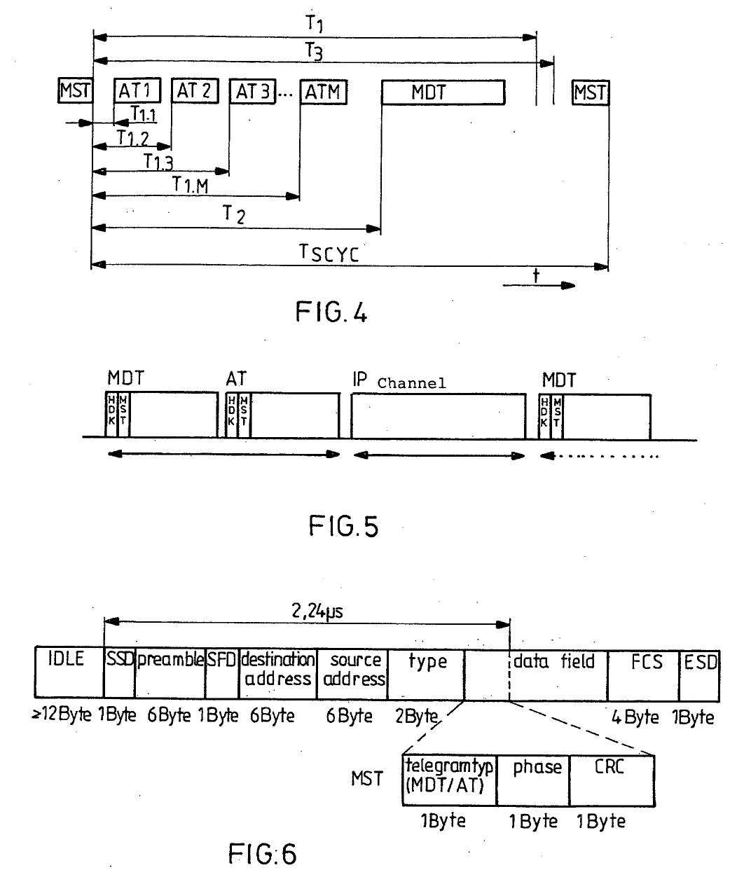

The applicant currently offers a distributed communication system of this type with a ring-type structure on the market, called the SERCOS Interface® (SErial Real Time COmmunication System). This system generates and sends control signals via a central participant to further participants. The further participants are typically connected with the central participant via optical waveguides. The SERCOS interface® specifies strictly hierarchical communication. Data are exchanged in the form of data blocks, the “telegrams” or “frames”, between the controller (master) and the substations (slaves) in temporally constant cycles. The further participants and/or substations do not communicate directly with each other. In addition, data contents are specified, i.e., the significance, depiction and functionality of the transmitted data are predefined to a significant extent. With the SERCOS interface®, the master connects the controller to the ring, and a slave connects one or more substations (drives or I/O stations). A plurality of rings can be linked to one controller, with the controller being responsible for coordinating the individual rings with each other. This is not specified by the SERCOS interface®. This communication system is preferably used for the closed-loop and open-loop control of distributed motors, e.g., synchronous or asynchronous motors. The further participants in the communication system are, therefore, the control devices for the closed-loop and open-loop control of a motor. The main applications for this communication system are, in particular, drives of machine tools, printing presses, operative machines, and machines used in general automation technology. With the SERCOS interface® there are five different communication phases. The first four phases (phase 0 through phase 3) serve to initialize the participants, and the fifth phase (phase 4) is regular operation. Within one communication cycle, every substation exchanges data with the controller. Access to the ring is deterministic within collision-free transmission time slots. FIG. 4 shows a schematic depiction of the communication cycle of regular operation, i.e., communication phases 3 and 4 of the SERCOS interface®. With the SERCOS interface® there are three types of telegrams: Master Synchronization Telegrams, Amplifier Telegrams and Master Data Telegrams. Master Synchronization Telegrams (MST) are sent out by the master participant. They contain a short data field, are used to define the communication phase and serve as the “clock”. Amplifier Telegrams (AT) are sent by slave participants and include, e.g., actual values of a drive controlled by the particular slave participant. Master Data Telegrams (MDT) are summation (framework) telegrams that contain data fields for all slave participants. The master uses Master Data Telegrams to transmit setpoint values to each slave. During initialization, every substation is notified of the start and length of its (sub-) data field. The SERCOS interface® defines the following types of data, i.e., operating data, control and status information, and data transmitted in a non-cyclic manner. Operating data (process data) are transmitted in every cycle. Examples include setpoint values and actual values. The length of the operating data range is parametrizable. It is established during initialization and remains constant during operation of the ring. The control information transmitted by the master participants to the slave participants, and the status information sent by the slave participants to the master participants are, e.g., release signals and “ready” messages. Data transmitted in a non-cyclic manner (service channel) include setting parameters, diagnostic data and warnings. Command sequences are also controlled via this non-cyclic transmission. As shown in the schematic depiction in FIG. 4, a communication cycle is started by the central participant sending out an MST. All communication-specific times are based on the end of this short (approx. 25 Πs-long) telegram. The substations now send their Amplifier Telegrams (ATi) in succession, in their respective transmission time slots, starting with T_{1,i}. After the last AT, the master sends the MDT, starting at T₂. The next cycle begins with another MST. The time interval between two MSTs is referred to as SERCOS cycle time T_{SYNC}. With the SERCOS interface®, communication is synchronized with the end of the MST. A synchronization telegram is generated by the central participant—preferably at equidistant intervals—and launched into the communication ring. In the closed-loop controllers, a time parameter typically links receipt of the synchronization telegram and the synchronization signal with the processing of setpoint/actual values, which results in a determination and allocation of open-loop and closed-loop parameters to the particular servo motors.

In particular, when the amplifier telegrams are configured as summation telegrams (in contrast to the depiction illustrated in FIG. 4, in which individual telegrams are used as amplifier telegrams), it is difficult to detect the loss of one of the further participants. In so doing, actual data from an amplifier telegram that was falsely assumed to be correct can greatly impair proper operation of the communication system.

The object of the present invention, therefore, is to avoid the disadvantages of the related art and, in particular, to further develop the method mentioned initially such that loss of a participant is reliably detected.

This object is attained with a method of the type described initially in that the central participant adds a predetermined entry to the telegrams in at least one location assigned to the at least one further participant, and that the at least one further participant adds, to the telegram, his data to be transmitted to the central participant such that the entry added by the central participant is at least partially overwritten.

According to the present invention, the central participant therefore carries out a reset in the appropriate telegram areas in the (amplifier) telegrams to enable easy detection as to whether one of the further participants has added data to the telegram. This therefore results in easy detection of the loss of a participant, which means the data contained in the corresponding telegram areas are not usable or valid. The present invention makes it possible to realize a “watch dog” for the further participant.

According to a preferred embodiment of the present invention, every time after it receives the telegram transmitted to it by the central participant, the at least one further participant adds data to the telegram that differs from the predetermined entry. As a result, the probability of correct detection of the loss of a participant is increased.

Preferably, the data to be added by the at least one participant includes a predetermined date. The predetermined date and/or a predefined bit sequence is advantageously a unique identification data for the further participant, e.g., a special bit in a predefined location in the telegram or the address of the further participant in the communication system. By using the address of the further participant in particular, the correct addition of data by a further participant can be easily monitored using communication monitors on the central participant.

According to a preferred embodiment of the present invention, the telegrams are summation telegrams that include predetermined, various telegram fields for each of the further participants in the communication system. In conjunction with the present invention, enhanced protocol efficiency with regard for individual actual-value telegrams results with this embodiment.

Advantageously, to evaluate and/or process contents of a telegram transmitted by a further participant, a check is carried out in the central participant or in another of the further participants to determine whether the predetermined entry was at least partially overwritten. The present invention is therefore usable not only for communication between the further participants and the central participant, but also between the individual participants. By way of the advance check, it is determined before the start of the evaluation and/or processing whether the further participant in question actually transmitted current and valid data.

Advantageously, the predetermined date and/or the identification date of the at least one further participant is the frontmost entry and/or at least one bit, preferably exactly one bit, in the first transmitted data word in the data field of the telegram provided for the at least one participant. This results in an increase in the processing speed and easier implementation in the hardware and software to the extent that the check, according to the present invention, to determine the loss of a participant can be carried out immediately after the central participant (or another further participant) receives the frontmost entry and/or the first data word transmitted, which is typically received first. If loss of a participant of this type is detected, i.e., if the entry added by the central participant was not overwritten, further processing can be halted in a timely manner.

It is further preferred that the frontmost entry is copied by an assumed CPU into a memory location (e.g., dual ported RAM) as the last entry and is subsequently read out, from front to back, by an assumed communication unit and is added to the telegram. This embodiment is advantageous in an application, in particular, in which it can take more time for the assumed CPU to copy the data to the memory location than is provided in the communication cycle in the time slot provided therefor. Only when the frontmost entry in the telegram was actually copied to the memory location can it be ensured that the further participant has successfully added all of his data to the telegram in a consistent manner. If the copying of data had to be interrupted due to time having been exceeded, the assumed CPU is unable to set the frontmost entry, this entry being an indicator of validity.

It is generally preferred that the data field provided for the at least one further participant is filled with data from back to front by the at least one further participant. In this manner, the frontmost entry—which is added first to the telegram—is automatically copied last.

In this context it is further preferred that writing data from back to front is prepared accordingly in a prestage, i.e., the data are stored in the further participant. More exactly, it is preferred that the at least one further participant has written his data to be transmitted to the central participant in a memory location, the at least one further participant having written the predetermined date and/or the identification date to the memory location as the last entry, and the data being added to the telegram from the memory location in the reverse order in which the data were written to the memory location. This method can be carried out by an appropriate write routine with any memory, e.g., a RAM memory. A special memory component can also be provided for this that inherently specifies an order of this type, e.g., a LIFO (Last In First Out) memory.

Further preferred exemplary embodiments of the present invention are disclosed in the dependent claims.

The present invention, further features, objectives, advantages and possible applications of the same are described in greater detail below based on the description of preferred exemplary embodiments, with reference to the attached drawings. In the drawing, the same reference numerals describe the same corresponding elements. All of the features described and/or depicted graphically represent the subject of the present invention, either alone or in any reasonable combination and, in fact, independently of their wording in the claims or their back-references. In the drawing:

FIG. 1 Shows a schematic depiction of a communication system known from the related art, which is located in a ring structure;

FIG. 2 Shows a schematic depiction of a communication system known from the related art, which is located in a bus topology;

FIG. 3 Shows a schematic depiction of a communication system known from the related art, which is located in a star topology;

FIG. 4 Shows a schematic depiction of the phases of the communication cycle of the SERCOS interface®—which is known from the related art—that are used for synchronization and regular operation;

FIG. 5 Shows a schematic depiction of the phase of the communication cycle of the communication system according to the present invention used for synchronization and regular operation; and

FIG. 6 Shows a schematic depiction of the telegram structure with embedded synchronization information of the communication system according to the present invention;

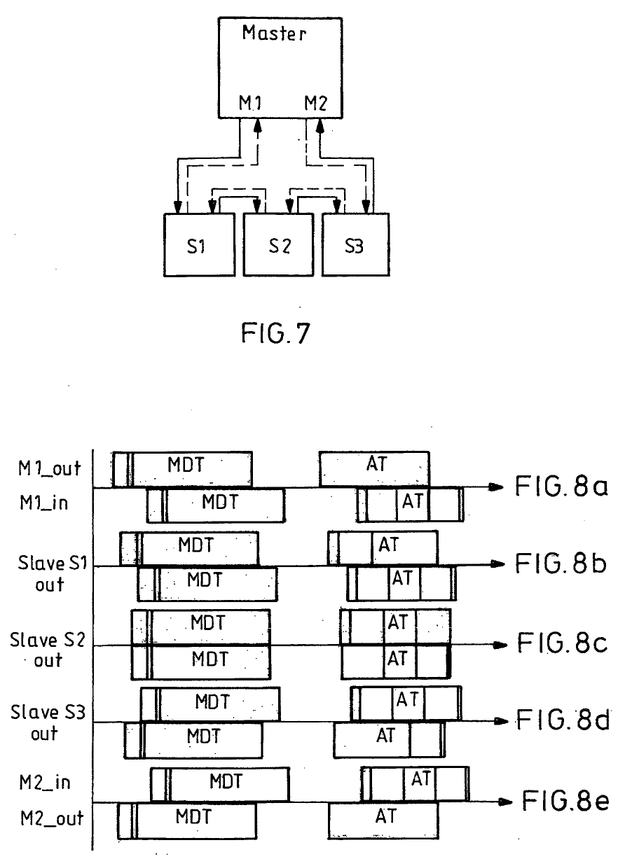

FIG. 7 Shows a schematic depiction of a communication system with a double-ring topology known from the related art;

FIGS. 8a through 8e Show schematic depictions of the communication taking place in FIG. 7, FIGS. 8a through 8e each showing the telegrams transmitted in the communication system with the particular participants of the communication system; and

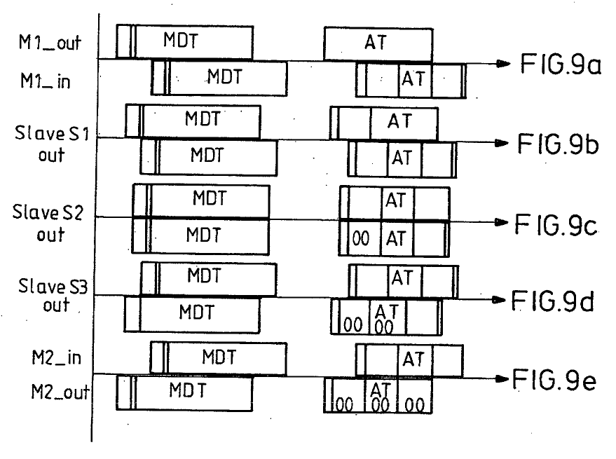

FIGS. 9a through 9e Show schematic depictions according to Figures FIG. 8a through 8e, the prefilling of telegram fields according to the present invention being depicted schematically.

The operating phase of communication carried out by the communication system according to the present invention is depicted schematically in FIG. 5 for the case of cyclic communication. In FIG. 5 one can see that data telegrams are exchanged between a central participant or master participant (or main station) and at least one further participant (slave participant or sub- or secondary station). The central participant is the station with which the secondary stations are to be synchronized. The data telegram sent out by the central participant, e.g., along a ring (refer to FIG. 1), is labelled MDT (=“Master Data Telegram”). The data telegram of the at least one secondary station is labelled AT (=“Amplifier Telegram”). FIG. 5 shows only one Amplifier Telegram. This corresponds to a case in which only one participant is provided (refer to FIG. 4). It is preferable, however, that the Amplifier Telegram AT shown in FIG. 5 is a summation telegram and includes corresponding telegram areas for a large number of further participants. Setpoint values for actuators to be controlled by the secondary stations are contained in the Master Data Telegram (MDT), for example. The Amplifier Telegram AT contains, e.g., corresponding actual values for replying to the central participant. According to the current exemplary embodiment of the present invention, the synchronization information is not in the form of a dedicated Master Synchronization Telegram MST (refer to FIG. 4). Instead the synchronization information is a data field MST in the Master Data Telegram MDT. The exact structure of the Master Data Telegram MDT is described in greater detail below with reference to FIG. 6. It has been noted, in this context, that the Master Synchronization Information Field MST is embedded at the beginning or in a front region of the Master Data Telegram MDT behind a header HDR. To simplify implementation of the communication system according to the present invention in the hardware and software, the Amplifier Telegram AT has the same structure as the Master Data Telegram MDT, although the Amplifier Telegram typically does not transmit synchronization information to the main station. This is advantageous, because both types of telegrams, i.e., MDT and ST, have the same offset in terms of the actual data, such as setpoint values and actual values. The part of the communication that includes the Master Data Telegram and at least one Amplifier Telegram is labelled “RT channel” in FIG. 5. As an option, the communication cycle can contain an IP channel as well as this RT channel. The IP channel is a time slot for transmitting data encoded in accordance with the Internet protocol. The duration of the communication cycle is also shown in FIG. 5. In accordance with the duration of the communication cycle in the SERCOS interface® (refer to FIG. 4)—in the case of which the duration is defined as extending from the end of one Master Synchronization Telegram to the end of the subsequent Master Synchronization Telegram—the communication cycle in the case of the communication system according to the present invention is defined as the “interval” from the end of the Master Synchronization Information Field of a Master Data Telegram to the end of the Master Synchronization Information Field of a subsequent Master Data Telegram. The next communication cycle therefore starts with the portion of the Master Data Telegram that follows the Master Synchronization Information Field, as indicated by the dotted arrow, which schematically represents the successive RT channel of the next cycle.

The structure of the Master Data Telegram is shown schematically in greater detail in FIG. 6. An idle phase (“IDLE”) that is at least 12 bytes long is provided before the start of the actual Master Data Telegram. The Master Data Telegram starts with a data field that is 1 byte in length. It is referred to as SSD (“Start Stream Delimiter”). This is a prefix that delineates the start of a transmitted data stream. This is followed by a preamble with a length of 6 bytes. The preamble can have the function of providing a start-up time for the hardware of the electronics in the communication system according to the present invention to detect that a telegram has been transmitted. This is followed by a data field SFD (“Start Frame Delimiter”) that delineates the start of the actual telegram or frame. The SFD field is 1 byte long. This is followed, in the Master Data Telegram, by the destination address and the source address for the telegram. Each of these two data fields has a length of 6 bytes. Following this is a type field which is 2 bytes long and is used to identify which type of network protocol is used in the subsequent data field. The data field itself comes next; its length is not specified exactly. For an Ethernet application, the data field can be up to 1,500 bytes long. The length of the data field typically depends on how many and which data are transmitted in the telegram. It is provided that an FCS (“Frame Check Sequence”) checksum 4 bits in length follows the data field. The FCS field therefore contains a checksum that enables the integrity of the data in the entire telegram to be checked. The transmitted data are ended by the 1-byte long field ESD (“End Stream Delimiter”), which is a suffix and is the end of the transmitted data stream.

The Master Synchronization Information Field is a portion of the data field of the telegram according to the present invention. More precisely, it is embedded in the Master Synchronization Information Field at the beginning of the data field. The Master Synchronization Information Field has a constant length and a starting field with a length of one byte, in which the telegram type is specified. In this field, it is specified in particular whether the current telegram is a Master Data Telegram MDT or an Amplifier Telegram AT. As explained above, the synchronization information is only ever required for a Master Data Telegram, since the secondary stations are to be synchronized with the central participant (=master). To simplify implementation in hardware and software, however, it is preferrable for the Amplifier Telegrams to have the same structure as the Master Data Telegram. An Amplifier Telegram can therefore also contain the Master Synchronization Information Field. For this case, the “Telegram type” field should therefore be filled with the information about the secondary station. The synchronization information itself is transmitted in a subsequent field (“phase”) with a length of one byte. The Master Synchronization Information Field ends with a CRC field (=“Cyclic Redundancy Check”), which uses a cyclic redundancy check to check the integrity of the data from the beginning of the data stream, i.e., from the SSD field to the phase field of the Master Synchronization Information Field. The CRC checksum is a unique number obtained by applying a polynomial to the bit pattern extending from the SSD field to the phase field. The same polynomial is used at the receiving station of the data telegram to generate a further checksum. The two checksums are compared to determine whether the transmitted data have been corrupted. As shown in FIG. 6, the end of a CRC field has a constant time interval from the beginning (start of the SSD field) of the Master Data Telegram. This constant time interval is preferably approximately a few microseconds long. In the exemplary embodiment shown, it is 2.24 microseconds long.

A redundant communication system of the type used in conjunction with the present invention is shown in FIG. 7. A double-ring system with two active rings moving in both directions is shown. Communication takes place simultaneously on both rings. The present invention is not limited to the structure shown, however. Further exemplary embodiments of the redundant communication system can be different communication systems and other topologies, e.g., redundant line structures. The communication system shown has two central participants M1 and M2, and three further participants S1, S2 and S3. The ring that runs in the counterclockwise direction as shown in FIG. 7 is referred to as ring 1, while the other ring—which runs in the clockwise direction—is referred to as ring 2. Ring 1 extends from central participant M1 to an input of participant S1. Ring 1 extends further from an output of participant S1 to an input of participant S2. Ring 1 continues from an output of participant S2 to an input of participant S3 and from an output of participant S3 to second central participant M1. The two central participants M1 and M2 can be interconnected, of course. Accordingly, ring 2 extends from an output of central participant M2 to an input of participant S3, from an output of participant S3 to an input of participant S2, from an output of participant S2 to an input of participant S1, and from an output of participant S1 to an input of further participant M1. The two rings, e.g., ring 1 and ring 2, are advantageously not operated independently of each other. To ensure reliable channel capacity for real-time requirements when an error occurs, the same information is exchanged on both rings so that, as a result of the simultaneous transmission on both rings and the increased redundancy, improved error tolerance to missing data blocks can be attained.

FIGS. 8a through 8e depict the transmission of telegrams on the two rings according to FIG. 7. The traffic at the various interfaces on ring 1 is shown in the top half of each of the FIGS. 8a through 8e, while the traffic at the various interfaces on ring 2 is shown in the lower half of each of the FIGS. 8a through 8e. Shown in the upper half of FIG. 8a, therefore, is the output of central participant M1, which is a component of ring 1. Shown in the lower half of FIG. 8a is the input of central participant M1, which is a component of ring 2. Accordingly, the upper half of FIG. 8b shows an output of further participant S1, which is a component of ring 1. The lower half of FIG. 8b shows a further output of participant S1, which is a component of ring 2. Accordingly, the upper half of FIG. 8c shows an output of participant 32 (S2?), which is a component of ring 1. The lower half of FIG. 8c shows a further output of participant 32 (S2?), which is a component of ring 2. Accordingly, the upper half of FIG. 8d shows an output of participant S3, which is a component of ring 1. The lower half of FIG. 8d shows a further output of participant S3, which is a component of ring 2. The input of central participant M2, which is a component of ring 1, is shown in the upper half of FIG. 8e. The output of participant M2, which is a component of ring 2, is shown in the lower half of FIG. 8e. The telegrams depicted in FIGS. 8a through 8e, namely a Master Data Telegram MDT and an Amplifier Telegram AT, both of which are configured as summation telegrams, correspond to the exemplary embodiments described above in conjunction with FIGS. 5 and 6. When FIGS. 8a through 8e are compared, it becomes clear that the transmission of the telegrams along the ring results in a corresponding time delay. The telegrams basically reach the individual participants of the communication depicted in FIG. 7 at different points in time. This applies in particular for participants M1, S1, S2 and M2 shown in FIGS. 8a, 8b, 8d and 8e. Due to the symmetry of the system, the corresponding telegrams arrive simultaneously at participant S2 (refer to FIG. 8c). In the right half of FIGS. 8a through 8e in particular, which show the amplifier telegram configured as a summation telegram, it is clear that a front, middle and rear section of the amplifier telegram is provided in each case for the three further participants S1, S2 and S3. When a section passes through participant S1, S2 or 33 (S3?), it is filled with data, e.g., actual-value data, from the particular participant. In the present exemplary embodiment, the synchronization information is not transmitted as it is in the related art (refer to FIG. 4) using dedicated Master Synchronization Telegrams. Instead, according to the present exemplary embodiment of the present invention (refer to FIGS. 5 and 6), the synchronization information is transmitted embedded in the Master Data Telegram, which results in increased protocol efficiency. The present invention is not limited thereto, however, and can also be used with dedicated Master Synchronization Telegrams MST (refer to FIG. 4). Per the depiction shown in the left half of FIGS. 8a through 8e, it is clear that the synchronization information, i.e., data field MST of the Master Data Telegram MDT, arrives at the particular participant S1, S2 and S3 at different times. As noted above, only participant S2 receives the synchronization information from both rings simultaneously, for reasons of symmetry. As a result of the present invention, the redundant synchronization information, which arrives at each participant in duplicate when an error does not exist, is used for synchronization. The different transit times differ from further participant to further participant, but they are known by the further participant and can therefore be compensated for. The procedure used to create a unique specification for synchronization triggering based on the synchronization information received by the further participants at different points in time is described in greater detail below with reference to FIG. 9.

The present invention will be explained in greater detail below with reference to FIGS. 9a through 9e. FIGS. 9a through 9e essentially correspond to FIGS. 8a through 8e. Reference is therefore made to the description above in this regard. In contrast to FIGS. 8a through 8e, the telegram fields assigned to the individual further participants S1, S2, S3 in the amplifier telegram AT are indicated. In the depiction in FIGS. 9a through 9e, the prefilling of telegram areas for the individual further participants by central participant M2 is shown only in the lower half (which corresponds to ring 2) for simplicity. Of course (although it is not shown), the same procedure can be used using amplifier telegram AT of ring 1 shown in the top half of FIGS. 9a through 9e. It is therefore clearly illustrated via the lower half of FIGS. 9e through 9c that the amplifier telegram, when it leaves central participant M2, has a predetermined entry set in the particular central participant at the beginning of the telegram area provided for the particular further participant. According to the illustration, the preset entry is composed of two leading zeroes “00”. As soon as the amplifier telegram leaves or has passed through particular further participants S1, S2 or S3, further participant S1, S2, S3 has written his data, e.g., actual value data recorded by actuators or sensors, to the particular telegram area of amplifier telegram AT configured as a summation telegram.

In each case, the predetermined entry “00” is preferably overwritten by the address of the further participant. This applies even when no data are to be added to the amplifier telegram because no corresponding actual values from sensors or actuators are available. After the amplifier telegram, which has passed through the ring, is received by further central participant M1, the particular central participant can detect whether one of the further participants S1, S2 or S3 did not participate. The method for overwriting the data preset by the central participant is carried out—via the further participant—by a communication controller, which reads out the data to be added from a memory location filled previously by a processor of the further participant or the slave functionality and adds the data to the amplifier telegram in one of the corresponding positions. The further participant adds his address field, as the most recent date, to the memory location after he has copied his actual values to the memory location. The address field or, in general, a field with a “validity indicator” is located at the beginning of the telegram area to be added to. As a result, it can be ensured that the data added to the amplifier telegram are consistent, even when the further participant copies his data to the memory location in a manner that is unsynchronized with the telegram processing. Only the address field must be copied in a single memory access (consistently). Consistency of the data is ensured by the fact that the process is carried out in the opposite direction, i.e., the copying to the memory area by the processor of the further participant and the reading-out of the data from the memory location by the communication controller.

The present invention was explained in greater detail above with reference to preferred exemplary embodiments of the same. For one skilled in the art it is obvious, however, that different transformations and modifications can be made without deviating from the idea on which the present invention is based.

1-23. (canceled)

24. A method of transmitting data in a communication system including a central participant and at least one further participant, comprising the steps of transmitting the data via telegrams from the at least one further participant to the center participant; transmitting the telegrams by the central participant to the at least one further participant before being sent out by the at least one further participant; adding by the central participant a predetermined entry in the telegram in at least one location assigned to the at least one further participant; and adding by the at least one further participant to the telegram the data to be transmitted to the central participant such that the entry added by the central participant is at least partially overwritten.

25. A method as defined in claim 24; and further comprising, every time after the last one further participant receives the telegram transmitted to it by the central participant, adding by the at least one further participant data to the telegram that differs from the predetermined entry.

26. A method as defined in claim 24; and further comprising providing a predetermined date in the data to be added by the at least one participant.

27. A method as defined in claim 24; and further comprising providing a unique identification date for the further participant in the data to be added by the at least one participant.

28. A method as defined in claim 27; and further comprising including in the identification data an address of the further participant in the communication system.

29. A method as defined in claim 28; and further comprising writing the information selected from the group consisting of the predetermined date, the identification date, the address of the further participant, and combinations thereof, in a location or locations of the entry added by the central participant.

30. A method as defined in claim 24; and further comprising including a specified number of zeros in the predetermined entry.

31. A method as defined in claim 24; and further comprising forming the telegrams as amplifier telegrams that include actual values determined by elements selected from the group consisting of sensors, actuators, and both.

32. A method as defined in claim 24; and further comprising forming the telegrams as summation telegrams that include predetermined, various telegram fields for each of the further participants in the communication system.

33. A method as defined in claim 24; and further comprising, in order to evaluate and process contents of a telegram transmitted by a further participant, carrying out a check in a participant selected from the group consisting of the central participant and another of the further participants, to determine whether the predetermined entry was at least partially overwritten.

34. A method as defined in claim 26; and further comprising forming a date selected from the group consisting of the predetermined date, the identification date, and both of the at least one further participant, as a front most entry in a data field of the telegram provided for the at least one further participant.

35. A method as defined in claim 26; and further comprising locating a date selected from the group consisting of the predetermined date, the identification date, and both of the at least one further participant in a transmission word furthest to a front in a data field of the telegram provided for the at least one further participant.

36. A method as defined in claim 34; and further comprising adding the front most entry as a last entry in the telegram.

37. A method as defined in claim 24; and further comprising filling a data field provided for the at least one further participant with data from back to front by the at least one further participant.

38. A method as defined in claim 27; and further comprising writing by the at least one further participant his data to be transmitted to the central participant in a memory location, writing by the at least one further participant the date selected from the group consisting of the predetermined date, the identification date, and both to the memory location as a last entry; and adding the data to the telegram from the memory location in a reverse order in which the data were written to the memory location.

39. A method as defined in claim 24; and further comprising forming the telegrams as Ethernet telegrams.

40. A communication system, including a central participant; at least one further participant; means for transmitting data via telegrams from the at least one further participant to the central participant, with the telegrams having been transmitted from the central participant to the at least one further participant before being sent out by the at least further participant; means for adding by the central participant a predetermined entry in the telegrams in at least one location assigned to the at least one further participant; and means for adding by the at least one further participant to the telegram his data to be transmitted to the central participant such that the entry added by the central participant is at least partially overwritten.

41. A communication system as defined in claim 40, wherein the communication system is a distributed communication system for decentralized control with a master-slave structure.

42. A communication system as defined in claim 40, wherein said communication system is located in an element selected from the group consisting of a ring structure, a linear bus topology, a star topology, and combinations thereof.

43. A communication system as defined in claim 42, wherein the communication system includes a ring structured with separate set point values and actual value telegrams.

44. A communication system as defined in claim 40, wherein the communication system is based on Ethernet physics.

45. An automation system, comprising, a communication system including a central participant; at least one further participant; means for transmitting data via telegrams from the at least one further participant to the central participant, with the telegrams having been transmitted from the central participant to the at least one further participant before being sent out by the at least further participant; means for adding by the central participant a predetermined entry in the telegrams in at least one location assigned to the at least one further participant; and means for adding by the at least one further participant to the telegram his data to be transmitted to the central participant such that the entry added by the central participant is at least partially overwritten; a control unit; and at least one further unit selected from the group consisting of a drive unit, an input unit, and an output unit, said control unit being connected with a central participant and one of the further units being connected with one of the at least one further participants.
